(19) United States
(12) Patent Application Publication
(10) Pub. No.: US 2018/0106553 A1
(43) Pub. Date: Apr. 19, 2018

(54) THERMAL MODULE CHARGING METHOD

(71) Applicant: PiMEMS, Inc., Santa Barbara, CA (US)

(72) Inventors: Payam BOZORGI, Santa Barbara, CA (US); Shannon C. Gott, Santa Barbara, CA (US); Timothy Reed, Santa Barbara, CA (US)

(73) Assignee: PiMEMS, Inc., Santa Barbara, CA (US)

(21) Appl. No.: 15/728,526

(22) Filed: Oct. 10, 2017

Related U.S. Application Data
(60) Provisional application No. 62/407,552, filed on Oct. 13, 2016.

(51) Int. Cl. F28D 15/02; B23P 15/26; B23K 26/24

(52) U.S. Cl. CPC F28D 15/0283; B23K 26/24; B23P 15/26

(57) ABSTRACT

The present application discloses a thermal ground plane that is charged by laser welding a cover on an aperture. Prior to sealing, the thermal ground plane is filled with a quantity of a working fluid, and the device is heated until the working fluid is boiling in the cavity. Accordingly, the cavity is filled with the working fluid and with a saturated vapor of the working fluid. When the saturated vapor has displaced other gases, the cavity is laser welded shut.

### CROSS REFERENCE TO RELATED APPLICATIONS

This US patent application claims priority to U.S. Provisional Application Ser. No. 62/407,552 filed Oct. 13, 2016 and incorporated by reference.

### STATEMENT REGARDING FEDERALLY SPONSORED RESEARCH

Not applicable.

### STATEMENT REGARDING MICROFICHE APPENDIX

Not applicable.

### BACKGROUND

This invention relates to two-phase cooling devices, and thermal modules.

Electronics employing various semiconductor devices and integrated circuits are commonly subjected to various environmental stresses. Applications of such electronics are extremely widespread, and utilize different semiconductor materials.

Many electronic environments, such as mobile devices or laptop computers have thin/planar configurations, where many components are efficiently packed into a very confined space. As a result, cooling solutions must also conform to thin/planar configurations. Heat spreaders in the form of thin thermal ground planes (TGPs) may be desirable for many electronic cooling applications.

### SUMMARY

Two-phase cooling devices are a class of device that can transfer heat with very high efficiency, by changing the phase of a working fluid through repeated cycles of condensation and evaporation. Two-phase cooling devices may include for example, heat pipes, thermal ground planes, thermal modules, vapor chambers and thermosiphons, and the like. The present application relates to a thermal ground plane (TGP) type of two-phase cooling device. More specifically, this application relates to a method for inserting the working fluid into the two phase cooling devices, and the enclosing of the working fluid within the device. The term “thermal module” refers to a device similar in function to a thermal ground plane, but which may not be planar in shape, but may have some more complicated profile. This application refers to, and can be applied to both thermal ground planes and to thermal modules, in general.

The method may include filling the two phase cooling device with a sufficient quantity of working fluid through an opening such as a charging port, heating the working fluid within the two phase cooling device until the fluid boils, boiling the fluid to displace the ambient gases with saturated vapor of the working fluid, and sealing the working fluid and saturated vapor within the device with a substantially hermetic seal.

In some embodiments the two phase cooling device may be formed as a thermal ground plane (TGP) structure suitable for use in electronic devices. In some embodiments, the working fluid may be water. In some embodiments, the sealing is done by laser welding a cap onto the opening of the TGP or directly welding the opening. In some embodiments, the TGP may include a wicking structure which draws the fluid through the device by capillary action.

In some embodiments, the TGP may comprise a microfabricated metal, such as but not limited to titanium, aluminum, copper, or stainless steel.

### BRIEF DESCRIPTION OF THE DRAWINGS

Various exemplary details are described with reference to the following figures, wherein:

FIG. 1A is a schematic illustration of an embodiment of a titanium based thermal ground plane (TGP) with a charging port on the left corner; FIG. 1B is a schematic illustration of an embodiment of a titanium based thermal ground plane (TGP) with a charging port on an intermediate point; FIG. 1C is a schematic illustration of an embodiment of a titanium based thermal ground plane (TGP) with a charging port on both corners;

FIG. 2A is a schematic illustration of an embodiment of a titanium based thermal ground plane (TGP) with a charging port and filled with a quantity of working fluid; FIG. 2B shows a heat source applied to the quantity of working fluid;

FIG. 3A is a schematic illustration of an embodiment of a titanium based thermal ground plane with a charging port, wherein the working fluid is boiling; FIG. 3B is a schematic illustration of an embodiment of a titanium based thermal ground plane with a charging port, wherein the working fluid is boiling and the cap is applied to the charging port and sealed;

FIG. 4 is temperature vs volume phase diagram of a water working fluid, showing the charging process;

FIG. 5 is an exemplary flowchart of the novel charging method;

FIG. 6 is schematic illustration of an embodiment of a laser welding apparatus suitable for sealing the titanium based thermal ground plane with a charging port; and

FIG. 7 is a schematic illustration of an embodiment of a titanium based thermal ground plane with a charging port, including a wicking structure, which is a suitable exemplary application of the charging technique.

It should be understood that the drawings are not necessarily to scale, and that like numbers may refer to like features.

### DETAILED DESCRIPTION

The first portion of this description is directed to the details of the novel method for filling a two phase cooling device with a sufficient quantity of a working fluid, while excluding, reducing or minimizing contaminants. The second portion discusses materials selections, provides details of an exemplary sealing method for the TGP, and describes an embodiment of the invention that includes a capillary wicking structure. This method may be used in place of, or in addition to, the method disclosed in U.S. Ser. No. 15/706,706, filed Sep. 16, 2017 and incorporated by reference in its entirety.

In the following description, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

In some embodiments, a charging method may be provided that allows the two phase cooling device to have a more controlled environment, and thus more predictable, reliable performance.

In some embodiments, a charging method may result in a smaller fraction of contaminants remaining in the device, because the ambient gases having been displaced by an amount of saturated vapor of working fluid, are contained within the cavity after charging.

In some embodiments, the charging method may allow a more accurate, predetermined amount of at least one suitable working fluid to be disposed in the two phase cooling device.

In some embodiments, a charging method may be provided that enables a high performance thin thermal ground plane with microfabricated wicking structure.

In some embodiments, a charging method may be provided that uses a titanium metal structure containing a highly pure and predetermined amount of suitable working fluid, and its saturated vapor, and enables a high-quality bond that seals the cavity and is less prone to leaking.

In some embodiments, the thermal ground planes disclosed here could be used to provide efficient space utilization for cooling semiconductor devices in a large range of applications, including but not limited to aircraft, satellites, laptop computers, desktop computers, mobile devices, automobiles, motor vehicles, heating air conditioning and ventilation systems, and data centers. Although much of the following discussion is directed to thermal ground planes (TGPs) it should be understood that the systems and methods also apply to thermal modules in general, which operate by phase change of a working fluid, but which may have some complex 3-dimensional shape such as bent, creased or serpentine. In some embodiments, and without loss of generality, water could be used as the working fluid. In some embodiments, and without loss of generality, helium, nitrogen, ammonia, high-temperature organics, mercury, acetone, methanol, Flutec PP2, ethanol, heptane, Flutec PP9, pentane, caesium, potassium, sodium, lithium, or other materials, could be used as the working fluid.

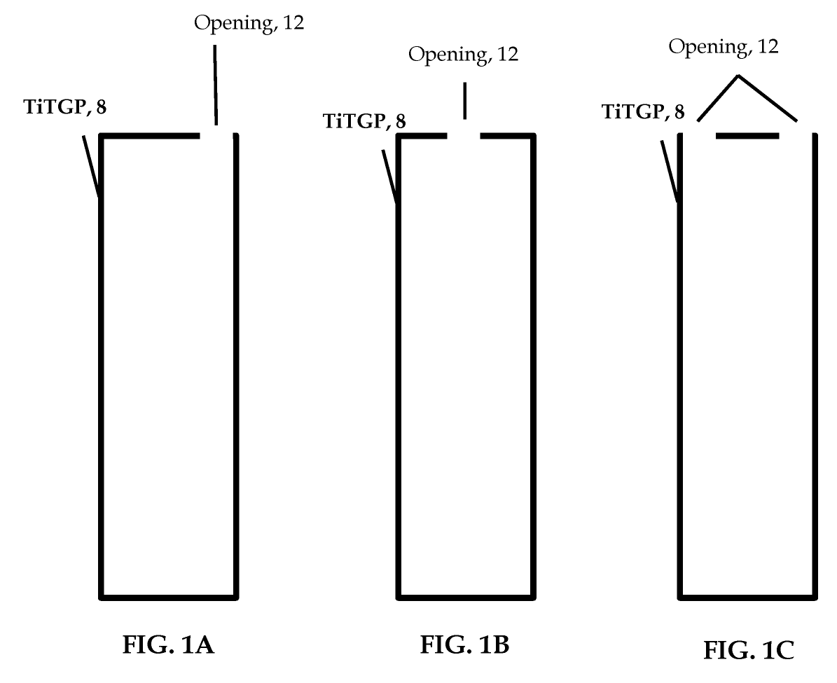

FIG. 1A is a schematic illustration of an embodiment of a titanium based thermal ground plane (TGP) with a opening 12. Although the titanium TGP is represented as a simple rectangle 8, it should be understood that titanium TGP 8 may include other features such as locating pins, attachment mechanisms, etc. The opening 12 may be located on one side or in the corner of one wall of the enclosure (FIG. 1A). It may optionally be located in the center of, or an intermediate point on a wall (FIG. 1B) or in both corners (FIG. 1C). The choice may depend on the details of the application, such as the amount of working fluid and the geometry of the device in which the titanium TGP is deployed. Although one opening is shown in FIG. 1C, other embodiments may have multiple openings in different parts of thermal module (TM), not only on top of TM or at each corners, but also anywhere on the thermal module.

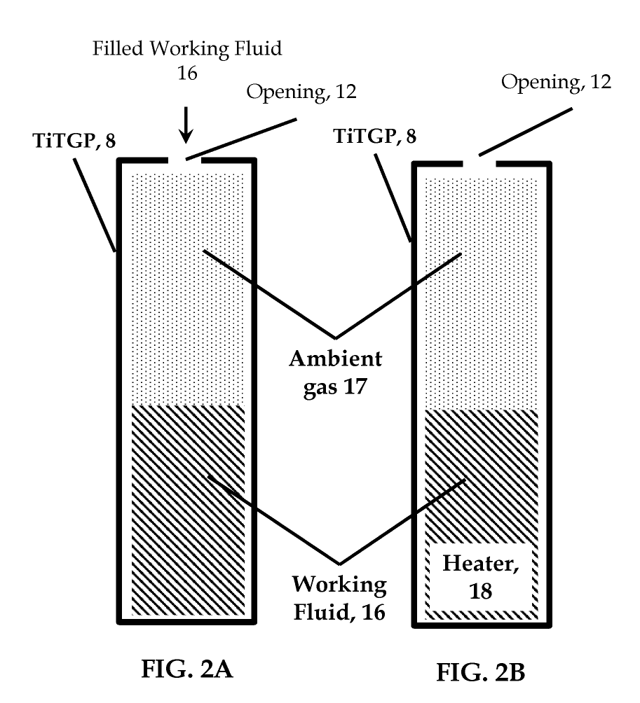

As shown in FIG. 2A, within the titanium TGP 8 may be a quantity 16 of working fluid, which may be introduced into a cavity in the interior of titanium TGP 8 through a opening 12, as shown in FIG. 2A. The working fluid 16 (water) is in liquid phase at this point, introduced through the aperture or opening 12 located in any of the positions shown in FIG. 1. At this point, there is working fluid occupying about ½ of the volume of the cavity, with the other ½ of the volume occupied by contaminant gases 17. In the next step, the titanium TGP may be heated to heat the working fluid enclosed therein (FIG. 2B). Although only one heater is shown on a bottom of the thermal module in FIG. 2B, it should be understood that this is exemplary only, and that multiple heaters may be used along the thermal module. Although the thermal module is shown as vertical, it should be understood that the thermal module may be in any orientation.

The heater 18 may be, for example, a focused laser, a heat gun, a Peltier or thermoelectric cooler (TEC), or an ohmic heater like a soldering iron. In one embodiment, the heater 18 may be an ohmic heater such as Ni Chrome wire embedded in a copper slab. The heater 18 may be applied to the lower portion of the titanium TGP, such that the heat is applied primarily to the quantity of working fluid 16 rather than other portions of the cavity or enclosure.

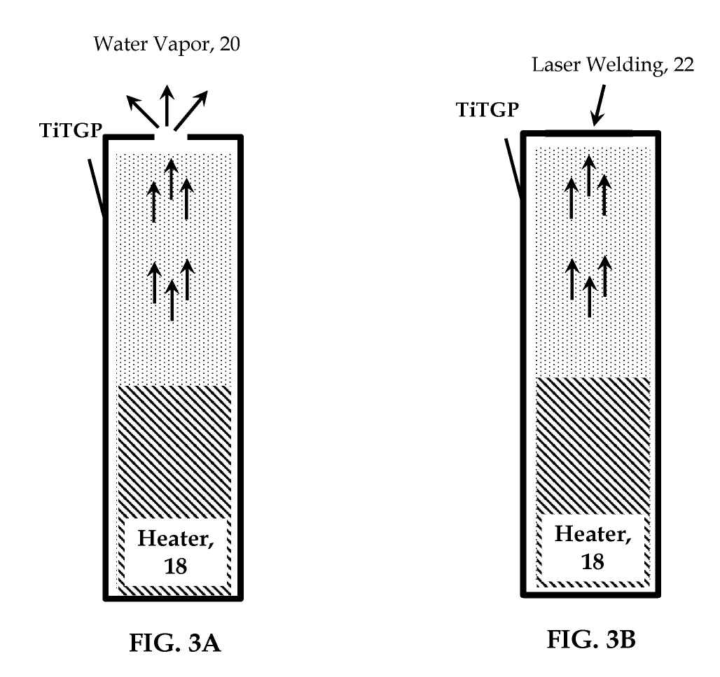

In FIG. 3A, the working fluid begins to boil, releasing a saturated vapor of the working fluid into the enclosure. At the boiling point, the vapor pressure reaches atmospheric pressure and the environment within the cavity contains a saturated vapor. The saturated vapor may displace the ambient gases, which escape through the opening 12. In some embodiments, the working fluid may be allowed to boil only for a few seconds, so as not to lose an appreciable amount of the working fluid through vaporization. The time period may be chosen by estimating the volume of the gases contained in the cavity above the fluid (reference number 17 in FIGS. 2A and 2B) and the amount of time needed to displace most or all of this gas with the saturated vapor of the working fluid. In the case of water as the working fluid, the saturated vapor is, of course, steam.

In FIG. 3B, a cap is affixed to the opening with a non-leaking, substantially hermetic seal. The substantially hermetic seal may leak less than about 1×10⁻¹⁰ atm-cm³/sec Helium leaking rate. The sealing methodology may be a welding (cold or hot welding), solder or adhesive, for example. In the embodiment described below, the cap is laser welded to the TGP enclosure 8.

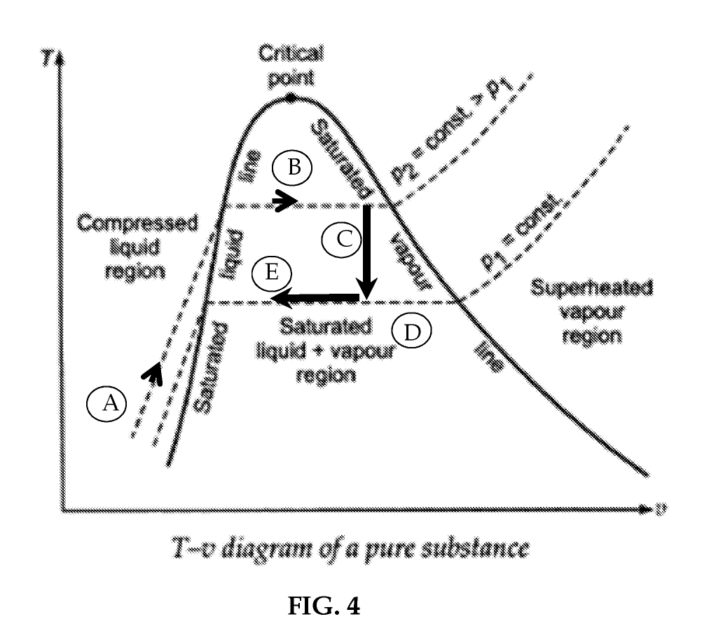

FIG. 4 is the temperature (T) versus volume (V) curve for the water and is helpful in describing the process. The process within the cavity undergoes the conditions described by this figure as follows, and follows the path A to B to C to D to E. The conditions A-E are as follows:

A: The working fluid 16 (water) is in liquid phase at this point, introduced through the aperture or opening 12. At this point, there is working fluid occupying about ½ of the volume of the cavity, with the other ½ of the volume occupied by contaminant gases 17.

B: The heater 18 heats up the water liquid 16 and raises the liquid temperature of the fluid until it starts boiling. At this point the water inside of titanium TGP is in a saturated liquid-vapor 20 state.

C: The opening 12 may be sealed using laser welding approach, for example, while the water inside of titanium TGP is still in saturated liquid-vapor form. The cap may also be sealed using a solder, cement, glue, or other welding approach, for example.

D and E: The heater is turned off and therefore the temperature drops off rapidly. When the saturated liquid-vapor temperature drops, then the pressure inside of the titanium TGP also drops and most of the vapor inside of titanium TGP is condensed at this point, but still in saturated liquid-vapor state as depicted in FIG. 4.

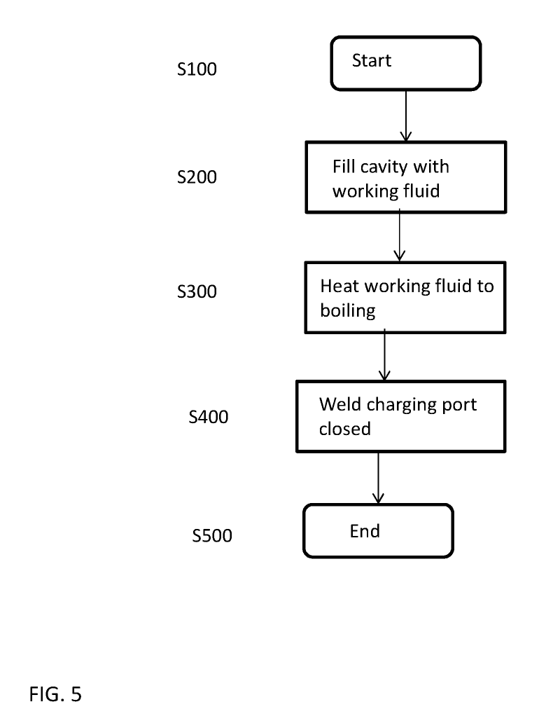

Accordingly, the novel charging method may include the following steps for the embodiment wherein the working fluid is water: The method is illustrated in FIG. 5. The method begins in step S100.

The titanium TGP 8 is fully sealed except for the open area (charging port). The open area may define the charging port 12 used to fill the titanium TGP with water. This open area could be a charging port at a corner 12 (FIG. 1A) or in an intermediate point (FIG. 1B) or in both corners 12 (FIG. 1C), or multiple opening regions in different location of the thermal module or thermal ground plane.

The predetermined amount of working fluid 16, such as water, is introduced into the cavity of the titanium TGP 8 through the charging port 12 (Step S200). The wicking structure inside of the titanium TGP was already surface processed to be super hydrophilic (see wicking structure described below), therefore the filled water is wicked along the titanium TGP 8 uniformly

The titanium TGP 8 is heated using a heater 18 to boil the water inside of the titanium TGP 8, Step S300. The generated water vapor 20 inside of titanium TGP 8 may push the inside air out, FIG. 3A, such that the ambient gases are displaced by the saturated vapor At this point. the inside of titanium TGP 8 is fully occupied by saturated liquid 20, and little or no air or other contaminant gases remain inside.

A laser welder may be used to weld the open area 12 of the titanium TGP 8 while the water vapor 20 is still coming out, Step S400. Other sealing methodologies may also be used.

The heater 18 is turned off as soon as the laser welding is done. At this point the saturated liquid-vapor water 20 (working liquid) inside of titanium TGP 8 is cooled off and the pressure inside of the titanium TGP 8 is dropped off. This procedure yields the following results: (1) Saturated liquid-vapor 20 remaining inside of titanium TGP 8 at low pressure (lower than atmospheric pressure) allows titanium TGP 8 to operate at a lower temperature and (2) Little or no air is left inside the titanium TGP where it would otherwise act as a contaminant gas. The method ends in step S500.

A brief discussion of the choice of materials for the TGP, the laser welding technique suitable for this method, and the wicking structure follow.

Materials

Microfabricated substrates can be used to make more robust, shock resistant two-phase cooling devices, which may be in the form of Thermal Ground Planes (TGPs). Although a variety of materials for these substrates may be employed, metal, such as but not limited to titanium, aluminum, copper, or stainless steel substrates have been found suitable for TGPs.

The choice of metal can depend upon the details of the various applications and cost considerations. There are advantages to various metals. For example, copper offers the highest thermal conductivity of all the metals. Aluminum can be advantageous for applications where high thermal conductivity is important and weight might be important. Stainless steel could have advantageous in certain harsh environments.

Titanium has many advantages. For example, titanium has a high fracture toughness, can be microfabricated and micromachined, can resist high temperatures, can resist harsh environments, can be bio-compatible. In addition, titanium-based thermal ground planes can be made light weight, relatively thin, and have high heat transfer performance. Titanium can be pulse laser welded. Since titanium has a high fracture toughness, it can be formed into thin substrates that resist crack and defect propagation. Titanium has a relatively low coefficient of thermal expansion of approximately 8.6×10⁻⁶/K. The low coefficient of thermal expansion, coupled with thin substrates can help to substantially reduce stresses due to thermal mismatch. Titanium can be oxidized to form Nano Structured Titania (NST), which forms stable and super hydrophilic surfaces. The NST may be superhydrophilic. In some embodiments, titanium (Ti) substrates with integrated Nano Structured Titania (NST) have been found suitable for TGP's, rendering a titanium thermal ground plane, or titanium TGP.

Metals, such as but not limited to titanium, aluminum, copper, or stainless steel, can be microfabricated with controlled characteristic dimensions (depth, width, and spacing) ranging from about 1-1000 micrometers, to engineer the wicking structure and intermediate substrate for optimal performance and customized for specific applications. In some embodiments, the controlled characteristic dimensions (depth, width, and spacing) could range from 10-500 micrometers, to engineer the wicking structure for optimal performance and customized for specific applications.

The working fluid can be chosen based upon desired performance characteristics, operating temperature, material compatibility, or other desirable features. In some embodiments, and without loss of generality, water could be used as the working fluid. In some embodiments, and without loss of generality, helium, nitrogen, ammonia, high-temperature organics, mercury, acetone, methanol, Flutec PP2, ethanol, heptane, Flutec PP9, pentane, caesium, potassium, sodium, lithium, or other materials, could be used as the working fluid.

The current TGP can provide significant improvement over earlier titanium-based thermal ground planes. For example, the present invention could provide significantly higher heat transfer, thinner thermal ground planes, thermal ground planes that are less susceptible to the effects of gravity, and many other advantages. The titanium also enables the laser welding technique, described next.

Laser Welding

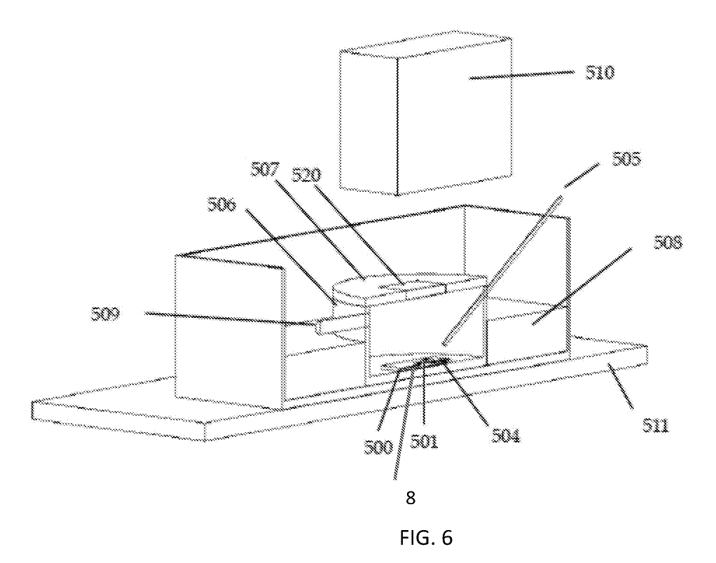

A sealing apparatus can optionally be used to seal the charging port of the Ti-based thermal ground plane TGP 8. An exemplary sealing apparatus is shown in FIG. 6. Elements of the sealing apparatus may include: an access port 507 to allow placement of titanium TGP 8 within the chamber and charging port 504/12 for placing working fluid in the TGP cavity, a heating element 500/18, an actuator 505 to manipulate the position of a cover 501 relative to the access port 504/12. Access port 504/12 can be sealed with a lid 501 in the apparatus that is configured to transmit light from the laser welder 510 to the structure. Vacuum fittings, such as vacuum line 509 may allow the chamber 506 to be evacuated.

The heater 500/18 may be applied to the metal structure of the TGP 8 to boil the working fluid. In other embodiments, the metal structure can be exposed to a high temperature by a variety of methods, including but not limited to, large heat sinks, thermal-electric coolers, laser and radiant heating, and an ohmic heater for example.

Once the working fluid is at a sufficiently high temperature (e.g. the boiling point, as is the case for some embodiments). At the boiling point, the vapor pressure reaches atmospheric pressure and the environment within the cavity contains a saturated vapor.

After the specified period of time, and while the structure is still being exposed to high temperature, the cover 501 may be positioned directly above the opening 504 in the surface of the TGP. In an exemplary embodiment, the cover 501 is positioned from being in close proximity to the opening 504/12, to being directly over the opening 504/12. In an example embodiment, this can be accomplished by using an actuator 505. In other embodiments, which are compatible with large-scale manufacturing processes, the cover 501 can be positioned by a variety of automated pick and place equipment.

Once the cover 501 is positioned to span the charging port 504/12 in the surface, the cover 501 is bonded to the metal structure 8 to provide a hermetic seal for the cavity. In a one embodiment, where the metal structure 8 is chosen to be titanium or a titanium alloy, a laser welder 510 can be used to micro-weld the cover to the titanium metal structure. The thermal ground plane 8 can be positioned to the laser welder with a positioning stage. Laser welding has the advantage that it is a form of non-contact welding, such that the cover and structure can be welded together, while simultaneously allowing saturated vapor to escape from the cavity. This prevents any potential sources of contamination to enter the TGP due the positive pressure of inside of TGP compared to outside pressure. As explained more fully below, this method may also displace contaminant non condensing gases, which may otherwise interfere with the functioning of the TGP. Furthermore, because of the positive pressure, very few contaminant molecules may come into close proximity to the region being welded. As a result, the weld between the cover and structure can be of very high quality, and will produce a highly reliable and robust hermetic seal.

In another embodiment, the loading, heating and sealing may take place in a vacuum chamber. In this embodiment, the charging port 504/12 may be opened, and the thermal ground plane metal structure 8 containing the cavity is placed in the vacuum chamber, and the cover 501 is positioned near the opening 504/12 in the surface. The cavity contained by the titanium TGP structure 8 is injected with a predetermined amount of working fluid. The heater 500/18 is applied to the TGP 8 while the entire assembly is contained in the vacuum chamber. The chamber is evacuated to a fraction of atmospheric pressure, such that boiling and saturated vapor are achieved at a lower temperature. When the fluid is boiling at the reduced pressure, the charging port may be sealed by placing the cover 501 over the charging port 504/12 and welding it shut. Accordingly, the method described here may be used at standard room temperature and pressure, but may also be used in evacuated conditions, of lower temperature and pressure.

In one embodiment, the cover 501 and structure 8 are welded by a pulsed Nd:YAG laser, which heats the titanium metal locally, but does not heat the metal structure at non-local distances from the point of the weld. The spot size of the laser may be between about 10 um to 1000 um. Another advantage of laser welding titanium is that there are limited contaminants that could contaminate the charged cavity, and negatively affect the performance of the two phase cooling device. Furthermore, the laser welder or metal structure can be translated using micro-positioning stages to facilitate the welding process. In other embodiments, a CO₂ laser may be used to perform the welding.

It should be understood that a sealing cap may be optional. In some embodiments, the opening in the TGP may be substantially hermetically sealed by welding directly the opening to seal it.

Wicking Structure

In some embodiments, the present application may provide two-phase cooling devices including a metal, such as but not limited to titanium, aluminum, copper, or stainless steel, substrate. A with many TGPs, the device may include an evaporation region where the working fluid changes phase from liquid to gas, and a condenser region where the working fluid condenses from vapor to liquid. These regions may absorb or release heat, and between the evaporator region and condenser region may be an adiabatic region.

The device may include a wicking structure, designed to promote the movement of fluid through the device by wicking action between closely spaced microstructures. The wicking structure may include a plurality of etched microstructures, wherein one or more of the microstructures has a height of between about 1-1000 micrometers, a width of between about 1-1000 micrometers, and a spacing of between about 1-1000 micrometers. In some embodiments a vapor cavity may be in communication with the plurality of metal microstructures. In some embodiments at least one intermediate substrate may be in communication with the wicking structure and the vapor region. In some embodiments, a fluid may be contained within the wicking structure and vapor cavity for transporting thermal energy from one region of the thermal ground plane to another region of the thermal ground plane, wherein the fluid may be driven by capillary forces within the wicking structure.

In some embodiments the two phase cooling device can be configured for high capillary force in the wicking structure, to support large pressure differences between the liquid and vapor phases, while minimizing viscous losses of the liquid flowing in the wicking structure. These high capillary force applications may make use of the novel charging method described above, because they benefit from tightly controlled, low fractions of contaminant gases to achieve reliable repeatable operation.

In some embodiments, the two phase cooling device may be a thermal ground plane which can be made very thin, and could possibly transfer more thermal energy than can be achieved by earlier TGP's. In some embodiments, different structural components could be located in an evaporator region, an adiabatic region and a condenser region. In some embodiments, an evaporator region may contain an intermediate substrate that comprises a plurality of microstructures that when mated with the wicking structure form high aspect ratio structures. In some embodiments, the intermediate substrate features are interleaved with the wicking structure features to increase the effective aspect ratio of the wicking structure.

In some embodiments, an adiabatic region may contain an intermediate substrate positioned in close proximity to the wicking structure to separate the vapor in the vapor chamber from the liquid in the wicking structure. In some embodiments, a condenser region may contain an intermediate substrate that has large openings (compared to the microstructure) so that the wicking structure is in direct communication with the vapor chamber. In some embodiments, a condenser region might not contain an intermediate substrate so that the wicking structure is in direct communication with the vapor chamber.

Each of these embodiments may make use of the novel charging method described above.

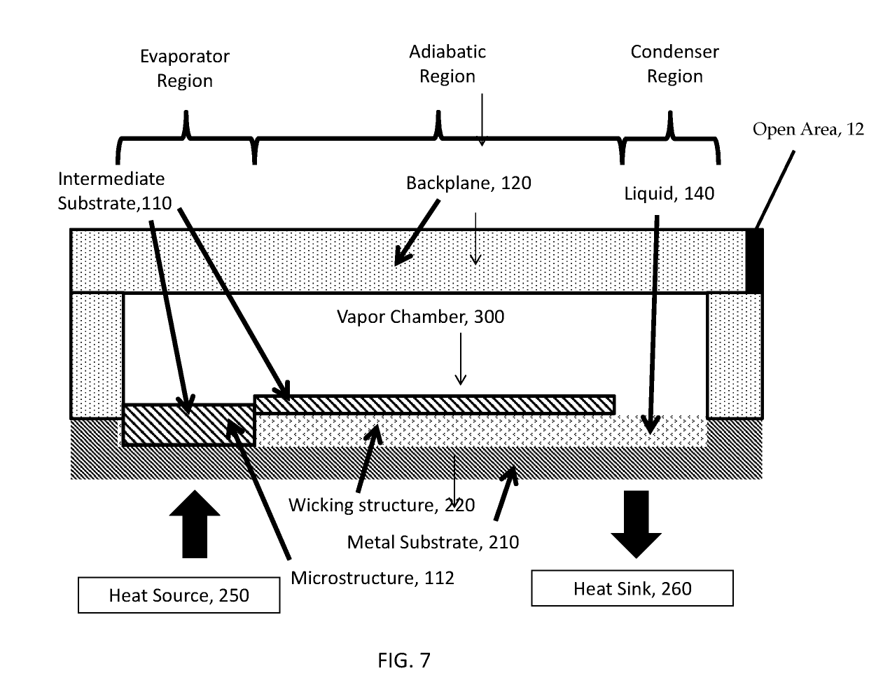

FIG. 7 illustrates an embodiment of a novel metal-based thermal ground plane with an intermediate substrate 110 in communication with a wicking structure 220 and a vapor chamber 300. The intermediate layer could comprise microstructures. This embodiment may make use of the novel charging method described above, because the narrow channels are particularly sensitive to contamination, so a tightly controlled, clean environment is desirable.

In some embodiments, a plurality of intermediate substrates 110 could be used, where at least one different intermediate substrate 110 could be used for each different region of the thermal ground plane. The plurality of intermediate substrates 110 could be positioned in close proximity to each other to collectively provide overall benefit to the functionality of the thermal ground plane.

In some embodiments, the intermediate substrate 110 could contain regions that are comprised of a plurality of microstructures, with characteristic dimensions (depth, width, and spacing) ranging from about 1-1000 micrometers. In some embodiments, the intermediate substrate 110 could contain regions that are comprised of a plurality of microstructures, with dimensions (depth, width, and spacing) ranging from 10-500 micrometers.

The at least one intermediate substrate 110 may contain regions that are comprised of a plurality of microstructures, regions that are comprised of solid substrates, and regions that are comprised of at least one opening in the at least one intermediate substrate 110 (that is large compared to the microstructures, and for example openings could range in dimension of 1 millimeter-100 millimeters, or 1 millimeter-1000 millimeters.

The vapor residing in the vapor chamber 300 can flow from the evaporator region through the adiabatic region to the condenser region. The heat sink 260 could absorb heat from the condenser region causing the local temperature to be lower than the saturation temperature of the liquid/vapor mixture, causing the vapor to condense into the liquid phase, and thereby releasing thermal energy due to the latent heat of vaporization.

The condensed liquid 140 could predominantly reside in the wicking structure 220 and could flow from the condenser region through the adiabatic region to the evaporator region as a result of capillary forces.

As a result it could be advantageous for high-performance heat pipes to: (1) exhibit minimal viscous losses for the liquid 140 flowing through the wicking structure 220, and to (2) exhibit maximal capillary forces in the evaporator region. In many practical thermal ground plane embodiments, minimal viscous losses and maximal capillary forces are difficult to achieve simultaneously. Introducing an intermediate substrate 110 with a plurality of microstructures, configured as appropriate in each of the three regions could provide a means in which the thermal ground plane could have reduced viscous losses in some regions, while exhibiting increased capillary forces in other regions, compared to earlier TGP's with more or less the same structure over a majority of the interior.

In some embodiments, supporting pillars (standoffs) are used to mechanically support the spacing between the backplane 120 and the wicking structure 220 and/or intermediate substrate 110. In some embodiments, the supporting pillars (standoffs) provide controlled spacing for the vapor chamber 300. The supporting pillars (standoffs) could be microfabricated using chemical wet etching techniques or other fabrication techniques (as described above). Accordingly, the backplane may include standoffs that are in communication with the intermediate substrate and/or the metal substrate, for structurally supporting the thermal ground plane.

In any case, the titanium TGP shown in FIG. 7 may benefit from the use of the novel method described above. In TGPs the amount of existing non-condensable gas (NCG) inside of the TGP after charging is should be minimized to achieve higher thermal performance. The residual NCG blocks the volume inside of the TGP and prevents the saturated vapor (from the boiling working fluid) to move from the evaporator to the condenser sections, therefore the heat cannot be transferred from evaporator to condenser. Accordingly, the residual NCG inside of the TGPs plays a significant role in thermal performance, and especially as the thickness of TGP is reduced (i.e., ultra thin TGPs). In this case, the volume inside of TGPs get smaller, and any residual NCG can occupy a larger proportion of the volume. As a result, the TGP may function poorly. The method disclosed here may reduce or minimize the amount of NCG inside of TGP during the charging process. To improve the performance of the TGP, the amount of residual NCG inside of TGP should be reduced or minimized. Accordingly, the method disclosed above may reduce or minimize the residual NCG inside of TGP by de-gassing water during the boiling process.

While an embodiment using titanium is disclosed here, it should be understood that this method may also be applied to other sorts of thermal ground planes using other materials. In any case, it may have the advantages described above, of displacing contaminant non-condensing gases.

In addition, because of the narrow fluid channels involved in this capillary-driven device, contamination of the working fluid should be kept to a minimum. As mentioned previously, the method described about displaces contaminant gases and replaces them with a saturated vapor of the working fluid.

Accordingly, a method is disclosed which includes filling a cavity with a volume of working fluid through a charging port, heating the working fluid to the boiling point; and sealing the charging port with a substantially hermetic seal. The working fluid may be water, and may be disposed in the cavity of the two phase cooling device and sealed by laser welding The laser spot size may be between about 10 um to about 1000 um. The method may further include allowing the working fluid to boil for an amount of time sufficient to substantially displace ambient gases with a saturated vapor of the working fluid. Substantially displaced may mean that at least about 50% of the ambient gas is displaced.

The heater may be at least one of a focused laser, an ohmic heater, a thermoelectric cooler, an oven, a soldering iron and a heat gun. The cavity may further include a wicking structure. The wicking structure may include at least one region having a plurality of microstructures with characteristic dimensions of about 1-1000 micrometers, and a plurality of microstructures that are interleaved with at least one region of the wicking structure to form high effective aspect ratio wicking structures, in at least one region of the thermal ground plane.

Sealing the cavity may comprise placing a cover over the charging port, and laser welding the cover to the charging port to substantially hermetically seal the cavity. The laser welding may be performed with a pulsed Nd:YAG laser. The charging ports may be in one or both corners or at an intermediate point in the cavity. The thermal ground plane may be made of titanium, and a surface of at least one region of the thermal ground plane may be comprised of superhydrophilic nanostructured titania (NST).

The working fluid may be water, on the order of 50 g. In some embodiments, the working fluid may fill about one half a volume of the cavity, such that the cavity is one half filled with the working fluid of water. When the cavity is sealed, the cavity is filled with the working fluid and a saturated vapor of the working fluid.

The wicking structure may comprise differently shaped structural components in an evaporator region, an adiabatic region and a condenser region. The wicking structure may transport thermal energy from one region of the thermal ground plane to another region of the thermal ground plane, wherein the fluid is driven by capillary forces within the wicking structure. The wicking structure may comprise a plurality of intermediate substrates positioned adjacent to the wicking structure to form narrow passages for fluid flow. The at least one different intermediate substrate may be used for each different region of the thermal ground plane. The vapor may flow from an evaporator region through an adiabatic region to a condenser region. The fluid may flow from a condenser region through an adiabatic region to an evaporator region.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Accordingly, the exemplary implementations set forth above, are intended to be illustrative, not limiting.

What is claimed is:

1. A method for charging a thermal module, comprising:
filling a cavity with a volume of working fluid through at least one opening; or multiple opening areas
heating the working fluid to the boiling point; and
sealing the at least one opening with a substantially hermetic seal.

2. The method of claim 1, wherein the working fluid is at least one of water, helium, nitrogen, ammonia, high-temperature organics, mercury, acetone, methanol, Flutec PP2, ethanol, heptane, Flutec PP9, pentane, caesium, potassium, sodium, and lithium.

3. The method of claim 1, wherein the working fluid is disposed in the cavity and sealed by laser welding with laser spot size between about 10 um to 1000 um.

4. The method of claim 1, wherein the heater is at least one of a focused laser, an ohmic heater, a thermoelectric cooler, an oven, a soldering iron and a heat gun.

5. The method of claim 1, wherein the cavity further includes a wicking structure.

6. The method of claim 5, wherein the wicking structure includes at least one region having a plurality of microstructures with characteristic dimensions of about 1-1000 micrometers.

7. The method of claim 6, wherein the wicking structure includes a plurality of microstructures that are interleaved with at least one region of the wicking structure to form high effective aspect ratio wicking structures, in at least one region of the thermal ground plane.

8. The method of claim 1, wherein sealing the cavity comprises placing a cover over the opening, and laser welding the cover to the opening to substantially hermetically seal the cavity or directly sealing the opening using laser welding.

9. The method of claim 8, wherein the openings are in the corners or at an intermediate point in the cavity.

10. The method of claim 1, wherein a surface of at least one region of the thermal ground plane is superhydrophilic using nanostructured titania (NST).

11. The method of claim 1, wherein the thermal module comprises titanium or other metals

12. The method of claim 1, wherein the laser welding is performed with a pulsed Nd:YAG laser, or a CO₂ laser.

13. The method of claim 1, wherein the volume of working fluid is about one half a volume of the cavity, such that the cavity is one half filled with the working fluid.

14. The method of claim 1, wherein when the cavity is sealed, the cavity is filled with the working fluid and a saturated vapor of the working fluid.

15. The method of claim 5, wherein the wicking structure comprises differently shaped structural components in an evaporator region, an adiabatic region and a condenser region.

16. The method of claim 5, wherein the wicking structure transports thermal energy from one region of the thermal ground plane to another region of the thermal ground plane, wherein the fluid is driven by capillary forces within the wicking structure.

17. The method of claim 5, wherein the wicking structure comprises a plurality of intermediate substrates positioned adjacent to the wicking structure to form 3D meniscus for working fluid inside of the wicking structures.

18. The method of claim 17, where at least one different intermediate substrate is used for each different region of the thermal ground plane.

19. The method of claim 5, wherein vapor flows from an evaporator region through an adiabatic region to a condenser region.

20. The method of claim 5, wherein fluid flows from a condenser region through an adiabatic region to an evaporator region.

21. The method of claim 1, further comprising:
allowing the working fluid to boil for an amount of time sufficient to substantially displace ambient gases with a saturated vapor of the working fluid.
